(19) United States
(12) Patent Application Publication
(10) Pub. No.: US 2002/0161838 A1
(43) Pub. Date: Oct. 31, 2002

(54) Method and apparatus for targeting information

(76) Inventors: Cilfford A. Pickover, Yorktown Heights, NY (US); Paul A. Moskowitz, Yorktown Heights, NY (US); Stephen J. Boies, Mahopac, NY (US); William Grey, Millwood, NY (US)

Correspondence Address: BUCKLEY, MASCHOFF, TALWALKAR, & ALLISON, 5 ELM STREET, NEW CANAAN, CT, 06840, US

(21) Appl. No.: 09/844,911

(22) Filed: Apr. 27, 2001

(51) Int. Cl. G06F 15/16

(52) U.S. Cl. 709/204; 709/206

(57) ABSTRACT

A system, method, apparatus, and computer program code for targeting information (e.g., advertisement, programming, membership application) includes associating a “social index” with both information segments and individuals and sending designated information segments to people meeting the social index associated with the information segment.

### FIELD OF THE INVENTION

The present invention relates to a method and apparatus for targeting information and, more particularly, embodiments of the present invention relate to methods, apparatus, and computer program code for targeting information to a user based on the social nature of the user.

### BACKGROUND OF THE INVENTION

Developments in communication technologies have resulted in a number of different delivery systems exist for information. For example, information can be sent or delivered to people via television, radio, print media, sites on the World Wide Web (the “Web”), email messages, etc. In many cases, however, information delivery is provided indiscriminately such that listeners, viewers, etc. receive the same information. For example, an advertisement broadcast during a television show may be shown to all people watching the television show.

In some situations, advertisers may want to target some advertisements to people who are most likely to remember or pass along the advertisement. However, since advertisers send their advertisements indiscriminately without regard to whether a person receiving the advertisement is a trendsetter or otherwise social person, the advertiser is limiting the effectiveness of the advertisement and the potential impact of the advertisement or product or service being advertised, in the marketplace.

It would be advantageous to provide a method and apparatus that overcame the drawbacks of the prior art. In particular, it would be desirable to provide a method and apparatus for targeting information to a person based on the social nature of the person.

### SUMMARY OF THE INVENTION

Embodiments of the present invention provide a system, method, apparatus, and computer program code for targeting information to a person based on the social nature of the user as embodied in a social index associated with the person. According to embodiments of the present invention an information segment, such as an advertisement, promotion, coupon, email message, audio file, music, etc., is associated with a social index and may be sent or otherwise provided to a person if the person meets or has the required social index.

A social index for a person may be based on one or more indicators of social interaction or behavior by the person, such as, for example, a number of buddy lists in which the person is included, the number of people in the person's buddy list, a number of emails or telephone calls the person sends and/or receives during a given time period, the affiliation or participation of the person in a social group or organization, the number of online chat sessions participated in by the person, a number of Web pages browsed by the person, etc.

Additional objects, advantages, and novel features of the invention shall be set forth in part in the description that follows, and in part will become apparent to those skilled in the art upon examination of the following or may be learned by the practice of the invention.

According to embodiments of the present invention, a method for targeting information includes determining a plurality of information segments, determining a social index of at least one person; selecting one of the information segments based, at least in part, on the social index; and providing a notification of the selected information segment. In other embodiments of the present invention, a method for targeting information includes determining a social index associated with an information segment; determining at least one person meeting the social index; and providing a notification of the person.

According to another embodiment of the present invention, a system for targeting information includes a memory; a communication port; and a processor connected to the memory and the communication port, the processor being operative to determine a plurality of information segments; determine a social index of at least one person; select one of the information segments based, at least in part, on the social index; and provide a notification of the selected information segment. In other embodiments of the present invention, a system for targeting information includes a memory; a communication port; and a processor connected to the memory and the communication port, the processor being operative to determine a social index associated with an information segment; determine at least one person meeting the social index; and provide a notification of the person.

According to a further embodiment of the present invention, a system for targeting information includes means for identifying a plurality of information segments; means for identifying a social index of at least one person; means for choosing one of the information segments based, at least in part, on the social index; and means for sending a notification regarding the selected information segment. In other embodiments of the present invention, a system for targeting information includes means for identifying a social index associated with an information segment; means for identifying a person meeting the social index; and means for sending a notification regarding the person.

According to yet another embodiment of the present invention, a computer program product in a computer readable medium for targeting information includes first instructions for identifying multiple information segments; second instructions for identifying a social index associated with at least one person; third instructions for selecting one of the multiple information segments based, at least in part, on the social index; and fourth instructions for sending data indicative of the selected information segment. In other embodiments of the present invention, a computer program product in a computer readable medium for targeting information includes first instructions for identifying a social index associated with an information segment; second instructions for identifying a person meeting the social index; and third instructions for sending data indicative of the person.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a block diagram of system components for an embodiment of an apparatus usable with the methods of FIG. 1 and FIG. 2;

FIG. 4 is a block diagram of a representative server of FIG. 3;

FIG. 5 is an illustration of a representative subject or social information database of FIG. 4; and

FIG. 6 is an illustration of a representative segment information database of FIG. 4.

### DETAILED DESCRIPTION

Applicants have recognized that there is a need for systems and methods which allow advertisements and other information to be targeted to an individual based on the social status or trend-setting nature of the individual. In addition, applicants have recognized that there is a need to provide systems and methods for determining appropriately social individuals to whom to send certain advertisements and other information.

Embodiments of the present invention provide such capabilities by associating a “social index” with both information segments and individuals and sending designated information segments to people meeting the social index associated with the information segment. An information segment may be or include, for example, a radio or television advertisement or program, an advertisement displayed on a World Wide Web (“Web”) site, a membership application, text information, coupon, promotional material, etc. These and other features will be discussed in further detail below, by describing a system, individual devices, and processes according to embodiments of the invention.

As one example implementation of the present invention, an advertiser or company that displays advertisements on a Web site may want to display the advertisement to people who are highly social and who are likely to discuss the advertisement with other people or share information about a product featured in the advertisement with other people. The advertiser or company might associate a social index or value with the advertisement. If the advertiser or company is paying to run the advertisement on a per display or per impression basis (often referred to as a CPM basis), the advertiser or company will get a better return on its advertising investment if the advertisement is displayed to “social” people. Thus, the advertiser or company may request that the advertisement be displayed primarily or only to those people who meet the desired social index associated with the advertisement.

As another example, an advertiser may want to place different print advertisements in magazines sent to different subscribers, based on the social indexes associated with each of the subscribers. The advertiser may provide the different advertisements to a fulfillment house that finalizes and distributes the magazine. A server or other device at the fulfillment house can receive the advertisement and social index information and match them accordingly with subscriber information so that the appropriate advertisement is sent to each subscriber.

### Process Description

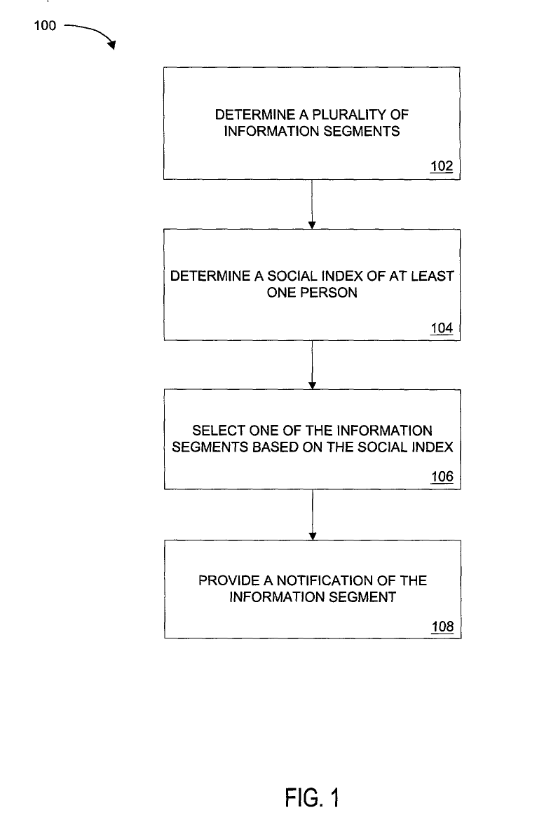

Reference is now made to FIG. 1, where a flow chart 100 is shown which represents the operation of an embodiment of the present invention. The particular arrangement of elements in the flow chart 100 is not meant to imply a fixed order to the steps; embodiments of the present invention can be practiced in any order that is practicable. In some embodiments, the method 100 may be implemented by a server or other device.

Processing begins at a step 102 during which a plurality of information segments are determined. As previously discussed above, an information segment can be or include a variety of things, such as, for example, a print advertisement, an electronic advertisement, promotion information, email message, coupon, music, education materials, entertainment, membership application, uniform resource locator (URL), image or graphic, software code, audio material, video material, animation, rich media, or an electronic signal or communication.

Determining a plurality of information segments during the step 102 may be done in a variety of ways. For example, a server implementing the method 100 may receive one or more of the plurality of information segments from a third party (e.g., an advertiser, a company placing advertisements) or retrieve one or more of the plurality of information segments from a database or third party. In some embodiments, a server or other device may request delivery of one or more information segments. In response, the server or other device may receive the information segments or information (e.g., a URL, a database address, a memory location) regarding where the information segments can be located, accessed, requested or retrieved or where the information segments are stored.

As a more specific example, an advertiser might provide a group of advertisements to a Web site server that can serve or display the advertisements on Web pages and target the advertisements so that each advertisement is only served to people meeting a social index associated with the advertisement. In this example, determining the information segments during the step 102 is completed by the server receiving the actual advertisements from the advertiser. As another example, the advertiser might provide a list of URL's where the advertisements can be retrieved or served from, the Web site server sending a request to retrieve or serve an advertisement to the URL associated with the advertisement when the advertisement is served or downloaded to a person meeting a social index associated with the advertisement. In this example, determining the information segments during the step 102 is completed by the server receiving information regarding the location or electronic address of the advertisements from the advertiser as opposed to the advertisements themselves.

In some embodiments, the information segments determined during the step 102 may have a social index assigned to them. In other embodiments, an entity (e.g., an advertiser) or a server or other device implementing the method 100 may assign or establish a respective social index to one or more of the information segments determined during the step 102 or receive a notification of an assignment of a respective social index to each of the information segments determined during the step 102.

A social index for an information segment may be determined in a number of ways. For example, a number may be assigned to an information segment based on subjective or objective measurements or standards, past experience with the information segment or similar information segments, etc. In some embodiments, the social index associated with an information segment can be adjusted over time as information regarding the success, distribution and word-of-mouth discussion of the information segment is obtained or as the needs of an advertiser or company placing or sending the information segment varies of time.

During a step 104, a social index is determined for at least one person. As previously discussed above, a social index may be computed in a variety of ways. For example, a social index number may be assigned to a person based on subjective or objective measurements or standards, past experience with the person, etc. In some embodiments, a person's social index may vary over time or be computed in real time.

A social index for a person can be based one or more factors such as, for example, an actual or expected number of entries in a buddy list associated with the person, an actual or expected number of buddy lists in which the person is included, a typing speed associated with the person, a number of emails sent or received by the person or expected to be sent or received by the person, a number of chat sessions participated in or expected to be participated in by the person, a number of chat messages posted or viewed by the person during one or more chat sessions, a number of Web pages browsed by the person or expected to be browsed by the person, a number of telephone calls made or received by the person or expected to be made or received by the person, a number of facsimiles sent or received or expected to be sent or received by the person, a number of printouts made or expected to be made by the person, a social index of another individual associated with the person, the person's occupation, residence, credit rating, geographic location, purchasing history, affiliations or groups that the person is a member of, an amount of media usage (e.g., television watching, radio listening) by the person, a number of postings made by the person on a bulletin board or in a newsgroup, the number of people the person carbon copies (i.e., “cc”) when sending an email message or other printed or electronic communication and/or the number of times the person carbon copies another person either in printed or electronic form when sending a communication, the number of entries in the person's rolodex or contact list (e.g., a number of email addresses, telephone numbers, postal addresses, etc. associated with the person), etc.

In some embodiments, a social index for a person might be based on the grammar, punctuation, syntax, word usage, etc. associated with the person. For example, a person's use of curse words, all capital letters, etc. in spoken or written communications may be taken into account when establishing a social index for the person.

In some embodiments, a social index for a person might be based on the “texture” of a person's communication (e.g., bulletin board posting, email, voicemail). That is, the cognitive, structural and/or word usage characteristics of the communication may be analyzed to give indications of the person's sociability, extroversion, and trend setting. As one example, the sophistication level of a person's email message may be inferred from the kinds of words used, grammar, word length of sentences, etc. As another example, a person who uses the terms “you should,” “I advise,” “take a look at,” “try this,” etc. may be judged to be influential and given a higher social index.

As will be discussed in more detail below, in some embodiments, an information segment can be provided to anyone who meets (i.e., has or exceeds) the social index associated with an information segment. In other embodiments, an information segment might be provided to a group of people if the total or average social index for the group meets a social index associated with the advertisement.

As a more specific example of how a social index for a person might be computed, a server or other device may determine the number B of entries in a person's on-line buddy list during a designated time period, the number E of emails sent and received by the person during the designated time period, the number C of online chat sessions the person has participated in during the designated time period, and the number W of Web pages browsed by the person during the designated time period. The social index S for the person may be computed by using a formula that takes into account these parameters, which may relate to sociability or trend setting. For example, the formula for the person's social index could be S=(a×B)+(b×E)+(c×C)+(d×W) where a, b, c, and d may be weighting factors that emphasize or de-emphasize various components of the social index S.

The social index for a person or a group of people may be computed in real time based on current factors or conditions or computer periodically and stored in a database for use and access. In some embodiments, a server or other device may store, update or maintain a database of social indexes or information used to compute social indexes. Thus, determining a social index during the step 104 might be or include receiving a notification of a social index from a third party or device, accessing a database where social index information is stored, retrieving the social index for a designated person, or requesting delivery of social index information for one or more people.

In some embodiments, a social index for a person might be stored in an electronic “cookie” stored on the person's computer. When the person accesses a Web site, the Web site might retrieve or access the social index information from the person's computer to determine the social index for the person. The Web site can then select the appropriate advertisement during a later step 106 to serve to the person. Alternatively, the cookie might store an identifier associated with the person instead of the actual social index information for the person. The Web site might retrieve or access the cookie from the person's computer to obtain the person's identifier. The Web site may then access a database that stores social index information associated with personal identifiers to determine the person's social index.

During the step 106, one of the information segments determined during the step 102 are selected based on the social index determined during the step 104. For example, a server or other device might compare the social index determined during the step 104 to a social index associated with at least one of plurality of information segments determined during the step 102. Alternatively, the server might select one of the plurality of information segments determined during the step 102 that has a social index that meets (i.e., has or exceeds) the social index determined during the step 104. Thus, the method 100 involves finding an information segment that meets the social index determined during the step 104. In some embodiments, the social index for or associated with the information segment can be higher or larger than the social index determined during the step 104.

As a more specific example, assume that the values of a social index S range from zero (e.g., a person who never sends e-mails, has no buddies, never chats, and never browses the Web) to one hundred (e.g., a highly social and perhaps trend setting person). A threshold social index value T might be established such that when S is greater than T the person is considered a trendsetter and targeted with specific advertisements. Alternatively, there need be no threshold T, and advertisements may be sent as a function of the social index S. For example, the higher the social index score of a person, the higher degree of advertisement targeting for the person and the higher degree that an advertiser may study the person's buying, Web browsing, or social habits.

During a step 108, a notification is provided regarding the information segment selected during the step 106. The notification may include data indicative of the social index determined during the step 104, the information segment selected during the step 106, data indicative of the information segment selected during the step 106, an electronic address where the information segment can be found, stored, retrieved, accessed, or requested, etc. The notification might be or include an email message, an HTTP (Hypertext Transfer Protocol) request or message, an electronic signal, an XML (Extensible Mark-up Language) feed, etc. The notification might be sent to one or more people or one or more devices.

As an example of the step 108, an advertisement server determining which advertisement to serve to a person viewing a Web site via a Web site server may receive information regarding one or more available advertisements and an identifier for the person. The advertisement server may select one of the advertisements during the step 106 based on the social index for the person and provide a message back to a Web site server regarding which one of the advertisements the Web site server should serve or display to the person. Thus the advertisement server is conducting the steps 102, 104, 106, and 108 but is not actually providing the advertisement selected during the step 106. In other embodiments, the advertisement server may include the selected advertisement as all or part of the notification sent to the Web site server during the step 108.

Providing a notification during the step 108 of the information segment determined during the step 106 may include providing the selected information segment to one or more meeting the social index determined during the step 104, serving the selecting information segments for display on a Web page, downloading or retrieving the selected information segments, including the selected information section as all or part of the notification, providing the selected information segment to one or more user devices (e.g., computer, television, cable set-top box, personal digital assistant), providing an electronic communication indicative of the selected information segment, providing data indicative of the selected information segments to one or more people or devices, providing an electronic address where the selected information segment can be found, requested, retrieved, stored, etc.

In some embodiments, a notification might be sent to a person associated with the person for whom the social index was determined during the step 104. For example, the person involved in the step 104 might have a buddy list, email contact list, telephone contact list, chat session attendee list, etc. The notification sent during the step 108 might be sent to one of the people on the buddy list, one of the people on the email contract list, etc. or to a device associated with one of the people. In some embodiments, a person associated with the person for who the social index was determined during the step 104 might be considered as a “follower” who may follow the advice, instructions, etc. provided to them.

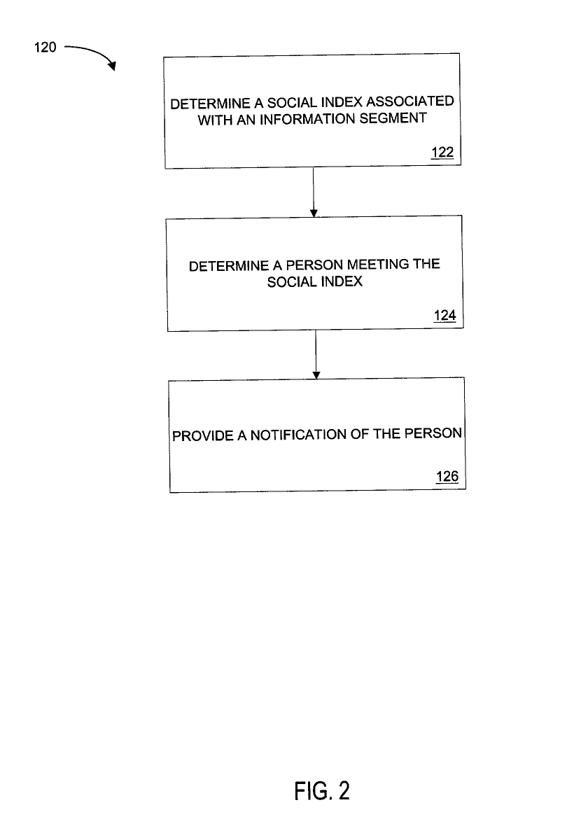

Reference is now made to FIG. 2, where a flow chart 120 is shown which represents the operation of an embodiment of the present invention. The particular arrangement of elements in the flow chart 120 is not meant to imply a fixed order to the steps; embodiments of the present invention can be practiced in any order that is practicable. In some embodiments, the method 120 may be implemented by a server or other device.

The method 120 may be used to determine which of several people to send a particular information segment. For example, an advertiser may provide commercials to a cable company that can be inserted into television signals sent by the cable company to individual cable subscribers. The cable company may determine a social index associated with one or more of the commercials and a social index with one or more of the subscribers. The cable company can then provide advertisements to appropriate subscribers based on the social index. The cable company may send a notification of which advertisement is sent to which subscriber to the advertiser and/or to the subscriber. The notification sent to the subscriber may include or be part of the advertisement itself. If the subscriber has advertisements previously stored on his or her cable set-top box, the notification sent to the subscriber may include an identifier that tells the set-top box which advertisement to insert in television programming watched by the subscriber and perhaps even when to insert the advertisement in the television programming.

Processing begins at step 122 during which a social index associated with an information segment is determined. The step 122 is similar to the step 104 previously discussed above.

Determining a social index associated with an information segment during the step 122 may be done by receiving a notification of the social index, accessing a database where social index information is stored, retrieving the social index from a device or person, requesting delivery of social index information, computing a social index in real time based on criteria or factors associated with the information segment, etc.

During a step 124, a person is determined that meets the social index determined during the step 122. The step 124 may include comparing the social index determined during the step 122 to each of a plurality of social indexes associated with a respective plurality of people, receiving a notification of the social index of one or more people, accessing a database where social index information of at least one person is stored, retrieving social index information regarding one or more people, requesting delivery of social index information, computing social indexes for one or more people, comparing a social index for one or more people to the social index determined during the step 122, etc.

During a step 126, a notification is provided of the person selected during the step 124. The step 126 is similar to the step 108 previously discussed above. The notification provided during the step 126 may include data indicative of the social index determined during the step 122, the information segment associated with the social index determined during the step 122 or data indicative of the information segment, an electronic address where the information segment can be found, stored, retrieved, accessed, or requested, a name, identifier, or electronic address of the person determined during the step 124, etc. The notification might be or include an email message, an HTTP request or message, an electronic signal, an XML feed, etc. The notification might be sent to one or more people or one or more devices.

### System

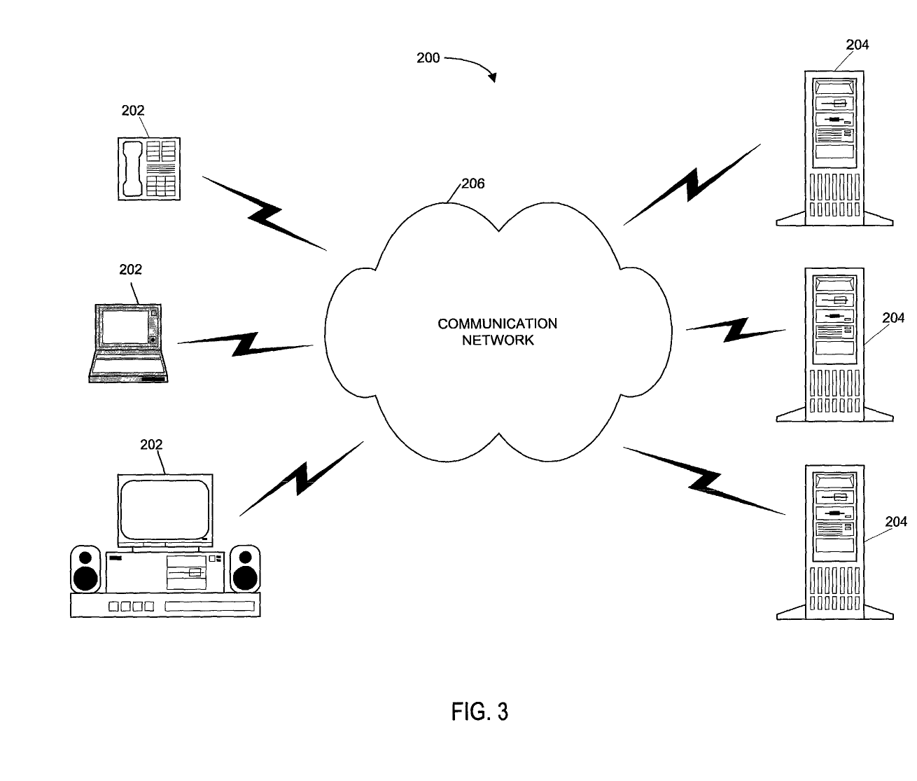

Now referring to FIG. 3, an apparatus or system 200 usable with the methods 100 and 120 is illustrated. The apparatus 200 includes one or more user devices 202 that may communicate directly or indirectly with one or more servers, controllers or other devices 204 via a computer, data, or communications network 206. For purposes of further explanation and elaboration of the methods 100 and 120, the method 100 and 120 will be assumed to be operating on, or under the control of, one the servers 204.

A server 204 may implement or host a Web site or be part of a cable, television or radio system. A server 204 can comprise a single device or computer, a networked set or group of devices or computers, a workstation, etc. In some embodiments, a server 204 also may function as a database server and/or as a user device. The use, configuration and operation of servers will be discussed in more detail below.

The user devices 202 preferably allow entities to interact with the server 204 and the remainder of the apparatus 200. The user devices 202 also may enable a user to access or retrieve Web sites, software, databases, information segments, etc. hosted, stored, maintained or operated by the servers 202. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, two-way pager, radio, cable set-top box, etc.

Many different types of implementations or hardware configurations can be used in the system 200 and with the methods 100, 120 and the methods disclosed herein are not limited to any specific hardware configuration for the system 200 or any of its components.

The communications network 206 might be or include the Internet, the World Wide Web, or some other public or private computer, cable, telephone or communications network or intranet, as will be described in further detail below. The communications network 206 illustrated in FIG. 3 is only meant to be generally representative of cable, computer, telephone or other communication networks for purposes of elaboration and explanation of the present invention and other devices, networks, etc. may be connected to the communications network 206 without departing from the scope of the present invention. The communications network 206 can also include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 206 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 3 may be equipped with a microchip transceiver that transmits and receives in a previously unused frequency band of 2.45 GHz that is available globally (with some variation of bandwidth in different countries). In addition to data, up to three voice channels are available. Connections can be point-to-point or multipoint over a current maximum range of ten (10) meters. Embodiments using Bluetooth technology may require the additional use of one or more receiving stations to receive and forward data from individual user devices 202 or servers 204.

Although three user devices 202 and three servers 204 are shown in FIG. 3, any number of such devices may be included in the system 200. The devices shown in FIG. 3 need not be in constant communication. For example, a user device may communicate with a server, or vice versa, only when such communication is appropriate or necessary.

### Server

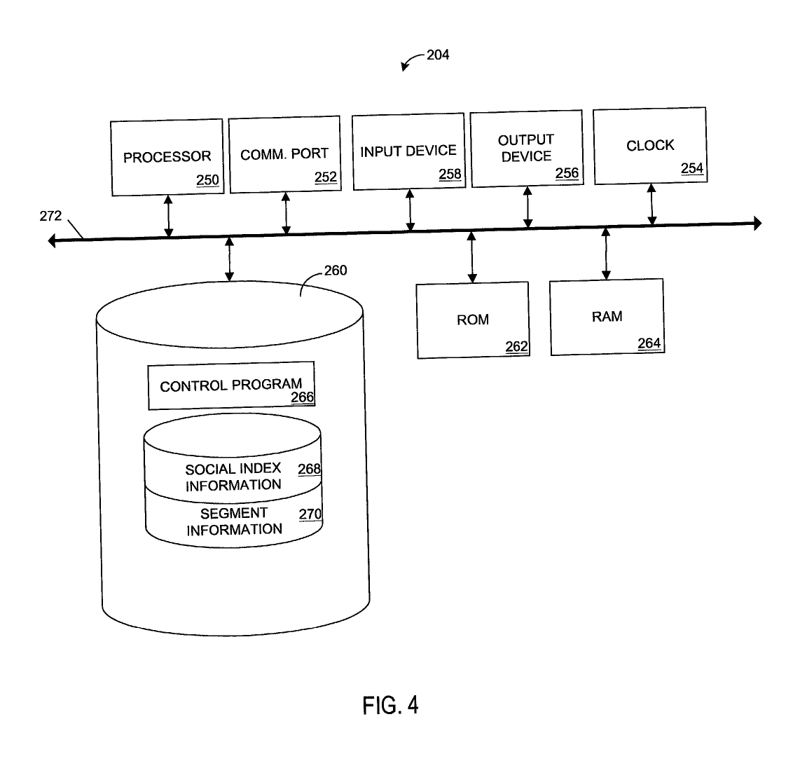

Now referring to FIG. 4, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications and/or information segments received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, information segments, software, databases, communications, device drivers, social indexes, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a ZIP™ disk drive, a compact disc drive, DVD drive, and/or a hard disk. The server 204 might also include ROM 262 and RAM 264 for additional storage and memory.

The processor 250 and the data storage device 260 in the server 204 may each be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding information segments, social indexes, users, etc. For example, information regarding social indexes of one or more people may be stored in a social index database 268 for use by the server 204 or another device or entity. Similarly, information regarding information segments may be stored in an information segment database 270 for use by the server 204 or another device or entity.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 272.

While specific implementations and hardware configurations for servers 204 devices have been illustrated, it should be noted that other implementations and hardware configurations are possible and that no specific implementation or hardware configuration is needed. Thus, not all of the components illustrated in FIG. 4 may be needed for a server implementing the method 100 or the method 120. Therefore, many different types of implementations or hardware configurations can be used in the system 200 and the methods disclosed herein are not limited to any specific hardware configuration.

### User Device

As mentioned above, user device 202 may be any of a number of different types of devices, including, but not limited to a personal computer, portable computer, mobile or fixed user station, workstation, network terminal or server, telephone, beeper, kiosk, dumb terminal, personal digital assistant, facsimile machine, two-way, radio, pager, etc. If desired, the user device 202 also may function as a server 204. In some embodiments, a user device 202 may have the same structure or configuration as the server 204 illustrated in FIG. 4 and some or all of the components of the server 204.

### Databases

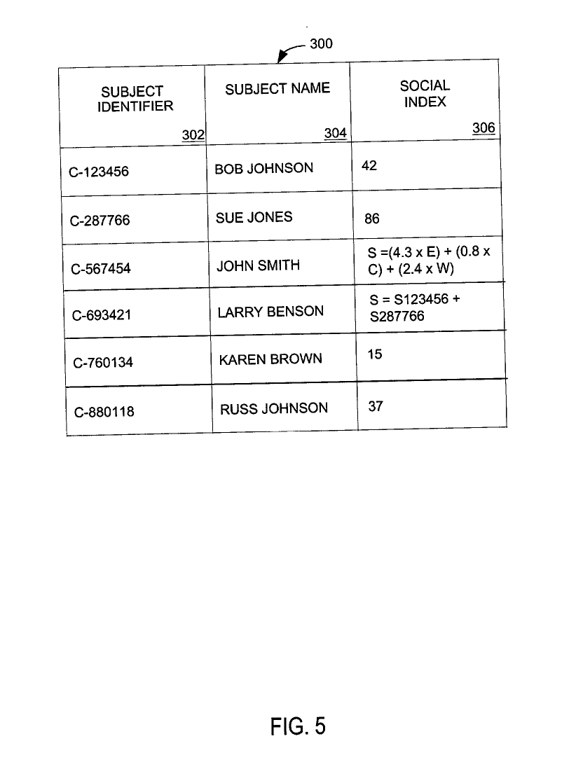

As previously discussed above, in some embodiments a server, user device, or other device may include or access a social index or subject database for storing or keeping information about social indexes for one or more people. One representative social index or subject database 300 is illustrated in FIG. 5.

The social index or subject database 300 may include an identifier field 302 which may include codes or other identifying information for one or more people or subjects, a subject name field 304 which may include names, addresses or other descriptive information for the subjects identified in the field 304, and a social index field 306 which may include information regarding the current social indexes of the subjects identified in the field 302, formulas for computing social indexes of the subjects identified in field 302, factors to be taken into account when computing social indexes for the subjects identified in the field 302, etc. Other or different fields also may be used in a social index or subject database. For example, a social index or subject database may include information regarding or more additional people associated with subjects, the information segments previously sent or provided to the subjects, the dates/times when information segments were provided to subjects, the format of notifications to be sent subjects, etc.

As illustrated in the representative database 300 of FIG. 5, the subject identified as “C-123456” in the field 302 is named “BOB JOHNSON” and has a social index of “42”. The subject identified as “C-567454” in the field 302 is named “JOHN SMITH” and his social index is computed by using the formula “S=(4.3×E)+(0.8×C)+(2.4×W)”. The values for “E”, “C” and “W” may be determined in real time and thus the social index S for “JOHN SMITH” may vary over time. The subject identified as “C-683421” in the field 302 has the name “LARRY BENSON” and his social index is computed by using the formula “S=S123456 +S287766”, which may indicate the social index for “LARRY BENSON” is the sum of the social indexes for the subjects identified as “C-123456” and “C-287766” in the field 302.

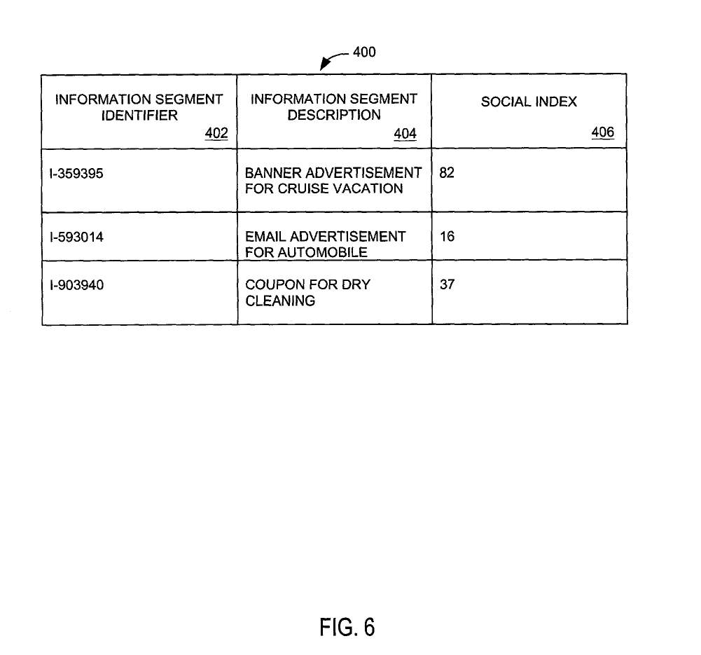

As previously discussed above, in some embodiments a server, user device, or other device may include or access an information segment database for storing or keeping information about one or more information segments. One representative information segment database 400 is illustrated in FIG. 6.

The information segment database 400 may include an information segment identifier field 402 which may include codes or other identifying information for one or more information segments, an information segment name field 404 which may include names, addresses or other descriptive information for the information segments identified in the field 404, and a social index field 406 which may include information regarding the current social indexes of the information segments identified in the field 402, formulas for computing social indexes of the information segments identified in field 402, factors to be taken into account when computing social indexes for the information segments identified in the field 402, etc. Other or different fields also may be used in an information segment database. For example, an information segment database may include information regarding the number of times an information segment has or can be used, a supplier of the information segment, a location or electronic address of an information segment, other targeting information associated with an information segment (e.g., the information segment only should be provided to woman, people over fifty, people with incomes over $100,000 a year), etc.

As illustrated in the representative database 400 of FIG. 6, the information segment identified as “I-359395” in the field 402 is a banner advertisement for a cruise vacation that may be displayed on a Web site and has a social index of “82” while the information segment identified as “I-593014” in the field 402 is an email advertisement for an automobile and has a social index of “16”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods 100, 120 can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for targeting information, comprising:
determining a plurality of information segments;
determining a social index of at least one person;
selecting one of said plurality of information segments based, at least in part, on said social index; and
providing a notification of said one of said plurality of information segments.

2. The method of claim 1, further comprising:
providing said one of said plurality of information segments.

3. The method of claim 2, wherein said providing said one of said plurality of information segments includes at least one of the following:
serving said information segment;
downloading said information segment;
inserting said information in print material;
emailing said information segment; and
including said information segment in an electronic communication.

4. The method of claim 1, wherein said determining a plurality of information segments includes at least one of the following:
receiving one or more of said plurality of information segments from a third party device;
retrieving one or more of said plurality of information segments from a database;
retrieving one or more of said plurality of information segments from a third party;
requesting delivery of one or more of said plurality of information segments;
assigning a respective social index to each of said plurality of information segments;
receiving a notification of an assignment of a respective social index to each of said plurality of information segments;
receiving an electronic address from where at least one of said plurality of information segments can be retrieved;
receiving an electronic address from where at least one of said plurality of information segments can be requested; and
receiving an electronic address from where at least one of said plurality of information segments is stored.

5. The method of claim 1, wherein said determining a social index of at least one person includes at least one of the following:
receiving a notification of said social index;
accessing a database where social index information is stored;
retrieving said social index; and
requesting delivery of social index information.

6. The method of claim 1, wherein said selecting one of said plurality of information segments based on said social index includes at least one of the following:
comparing said social index to a social index associated with at least one of said plurality of information segments;
selecting one of said plurality of information segments that has a social index that meets said social index.

7. The method of claim 1, wherein said providing a notification of said one of said plurality of information segments includes at least one of the following:
providing said one of said plurality of information segments to at least one person having or exceeding said social index.
serving said one of said plurality of information segments;
downloading said one of said plurality of information segments;
retrieving said one of said plurality of information segments;
including said one of said plurality of information segments in said notification;
providing said one of said plurality of information segments to one or more user devices;
providing an electronic communication indicative of said information segment;
providing data indicative of said one of said plurality of information segments;
providing an electronic address where said one of said plurality of information segments can be found;
providing an electronic address from where said one of said plurality of information segments can be requested; and
providing an electronic address from where said one of said plurality of in information segments can be retrieved.

8. The method of claim 1, wherein said information segment includes at least one of the following:
a print advertisement;
an electronic advertisement;
educational materials;
entertainment;
a promotion;
an email message;
a coupon;
a membership application;
a Uniform Resource Locator;
an image;
software code;
an electronic signal;
rich media;
audio material;
text material; and
an animation.

9. The method of claim 1, further comprising:
providing said one of said plurality of information segments to at least one person having or exceeding said social index.

10. The method of claim 1, wherein said notification includes at least one of the following:
data indicative of said social index;
said one of said plurality of information segments;
data indicative of said one of said plurality of information segments;
an electronic address where said information segment can be found;
an electronic address from where said information segment can be requested; and
an electronic address from where said information segment can be retrieved.

11. The method of claim 1, further comprising:
providing said notification to at least one other person associated with said person.

12. The method of claim 11, further comprising:
determining said at least one other person associated with said person.

13. The method of claim 12, wherein said determining said at least one other person associated with said person includes at least one of the following:
determining at least one other person meeting said social index;
determining at least one person included in a buddy list of said person;
determining at least one person who has been in electronic communication with said person;
determining at least one person who has participated in a chat session with said person;
determine at least one person who has made a telephone call to said person;
determine at least one person who has received a telephone call from said person;
determining at least one person who has received an email message from said person; and
determining at least one person who has sent an email message to said person.

14. The method of claim 1, further comprising:
receiving a request to determine said social index of at least one person.

15. The method of claim 1, further comprising:
adjusting said social index.

16. The method of claim 1, wherein said social index of said at least one person is based, at least in part, on at least one of the following:
a number of addresses associated with said at least one person;
a number of entries in a buddy list associated with said at least one person;
a number of buddy lists in which said at least one person is included;
a typing speed associated with said at least one person;
7 a number of emails sent by said at least one person;
8 a number of emails received by said at least one person;
a number of chat sessions participated in by said at least one person;
a number of chat messages posted by said at least one person during a chat session;
a number of chat messages viewed by said at least one person during a chat session;
a number of people carbon copied to by said at least one person when sending an email message;
a number of times said at least one person carbon copies at least one other person when sending an email message;
a number of Web pages browsed by said at least one person;
a number of telephone calls made by said at least one person;
a number of telephone calls received by said at least one person;
a number of facsimiles sent by said at least one person;
a number of facsimiles received by said at least one person;
a number of printouts made by said at least one person;
a number of emails expected to be sent by said at least one person;
a number of emails expected to be received by said at least one person;
a number of chat sessions expected to be participated in by said at least one person;
a number of Web pages expected to be browsed by said at least one person;
a number of telephone calls expected to be made by said at least one person;
a number of telephone calls expected to be received by said at least one person;
a number of facsimiles expected to be sent by said at least one person;
a number of facsimiles expected to be received by said at least one person; and
a number of printouts expected to be made by said at least one person.

17. The method of claim 1, wherein said social index of said at least one person is based, at least in part, on at least one of the following:
a number of email addresses associated with said at least one person;
a number of postal addresses associated with said at least one person;
a number of telephone numbers associated with said at least one person;
a social index of at least one other person;
an occupation of said at least one person;
an affiliation with a group by said at least one person;
a residence of said at least one person;
a credit rating of said at least one person;
a purchasing history of said at least one person;
a geographic location of said at least one person;
an amount of media usage by said at least one person;
texture of a communication sent by said at least one person;
texture of a communication received by said at least one person;
texture of a posting made by said at least one person;
a number of postings made by said at least one person on a bulletin board; and
a number of postings made by said at least one person in a newsgroup.

18. The method of claim 1, wherein said social index of said at least one person is based, at least in part, on at least one of the following:
a rate of change of a size of buddy list associated with said at least one person.
a number of emails sent by said at least one person during a designated period of time;
a number of emails received by said at least one person during a designated period of time;
a number of chat sessions participated in by said at least one person during a designated period of time;
a number of Web pages browsed by said at least one person during a designated period of time;
a number of telephone calls made by said at least one person during a designated period of time;
a number of telephone calls received by said at least one person during a designated period of time;
a number of facsimiles sent by said at least one person during a designated period of time;
a number of facsimiles received by said at least one person during a designated period of time; and
a number of printouts made by said at least one person during a designated period of time.

19. A method for targeting information, comprising:
determining a social index associated with an information segment;
determining at least one person meeting said social index; and
providing a notification of said at least one person.

20. The method of claim 19, wherein said determining a social index associated with an information segment includes at least one of the following:
receiving a notification of said social index associated with at least one information segment;
accessing a database where social index information is stored;
computing a social index for at least one information segment;
retrieving said social index associated with at least one information segment; and
requesting delivery of social index information for at least information segment.

21. The method of claim 19, wherein said determining at least one person meeting said social index includes at least one of the following:
comparing said social index to each of a plurality of social indexes associated with a respective plurality of people;
receiving a notification of said social index for at least one person;
computing a social index for at least one person
accessing a database where social index information of at least one person is stored;
retrieving said social index; and
requesting delivery of social index information for at least one person.

22. The method of claim 20, wherein said providing a notification of said at least one person includes at least one of the following:
emailing said notification to an email address associated with said at least one person;
sending said notification to a user device associated with said at least one person;
sending said notification to a device associated with a provider of said information segment;
sending said notification to a device associated with a distributor of said information segment;
including an identifier of said at least one person in said notification;
including a name of said at least one person in said notification;
including an email address of said at least one person in said notification;
including said information segment in said notification;
including an electronic address where said information segment can be found in said notification;
including an electronic address from where said information segment can be requested in said notification; and
including an electronic address from where said information segment can be retrieved in said notification.

23. The method of claim 19, further comprising:
providing said information segment to said at least one person.

24. The method of claim 19, further comprising:
providing said information segment to said at least one person.

25. The method of claim 19, further comprising:
assigning a social index to said information segment.

26. A system for targeting information, comprising:
a memory;
a communication port; and
a processor connected to said memory and said communication port, said processor being operative to:
determine a plurality of information segments;
determine a social index of at least one person;
select one of said plurality of information segments based, at least in part, on said social index; and
provide a notification of said one of said plurality of information segments.

27. A system for targeting information, comprising:
a memory;
a communication port; and
a processor connected to said memory and said communication port, said processor being operative to:
determine a social index associated with an information segment;
determine at least one person meeting said social index; and
provide a notification of said at least one person.

28. A computer program product in a computer readable medium for targeting information, comprising:
first instructions for identifying multiple information segments;
second instructions for identifying a social index associated with at least one person;
third instructions for selecting one of said multiple information segments based, at least in part, on said social index; and
fourth instructions for sending data indicative of said one of said multiple of information segments.

29. A computer program product in a computer readable medium for targeting information, comprising:
first instructions for identifying a social index associated with an information segment;
second instructions for identifying at least one person meeting said social index; and
third instructions for sending data indicative of said at least one person.
